(19) United States
(12) Patent Application Publication
(10) Pub. No.: US 2002/0072047 A1
(43) Pub. Date: Jun. 13, 2002

(54) System and method for generating composite video images for karaoke applications

(76) Inventors: Daniel R. Michelson, Des Plaines, IL (US); David X. Zhong, Buffalo Grove, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/736,906

(22) Filed: Dec. 13, 2000

Related U.S. Application Data
(60) Provisional application No. 60/170,508, filed on Dec. 13, 1999.

(51) Int. Cl. G09B 5/00

(52) U.S. Cl. 434/307 A

(57) ABSTRACT

A system and method for generating a video image for display during a Karaoke performance allows the image of a singer to be displayed together with the words and/or associated graphics of a song being performed. The video image of the text and/or graphics associated with the song is read from a CD+G disk or similar Karaoke media. The text/graphics for the song is then downscaled and relocated to a selected area of the output video image, such as the lower portion of the screen. The modified text/graphics image and the singer's image are then used to form a composite output video image for display on a video monitor.

### CROSS REFERENCE TO RELATED APPLICATIONS

This application claims the benefit of provisional patent application Serial No. 60/170,508, filed Dec. 13, 1999.

### TECHNICAL FIELD OF THE INVENTION

This invention relates generally to sing-along systems commonly known as “Karaoke,” and more particularly to the generation of video images for Karaoke applications.

### BACKGROUND OF THE INVENTION

Karaoke is a form of sing-along in which a person sings along with popular songs played back through a special Karaoke system. The voice of the singer is picked up by a microphone and used by the Karaoke system to replace the original singing in the songs, thereby creating an impression that the Karaoke singer is singing in accompany of a professional band. Karaoke singing, which started in Japan, is now one of the most popular entertainment activities in many Asian countries and is becoming increasingly popular in the United States, enjoyed by many people in Karaoke bars, restaurants, and private homes.

Besides the effect of substituting the original recorded singing with the voice of a Karaoke singer, another feature of Karaoke that contributes to its immense popularity is that the words of the songs are displayed on a video monitor, such as a television screen, in conjunction with the music. Displaying the words of a song being performed helps a Karaoke singer to sing along even if she does not remember or know all the words of the song. Currently, the music and words of songs recorded for purpose of Karaoke singing are typically stored on optical disks in a “compact disk plus graphics” (CD+G) format. During playback, a CD+G Karaoke player retrieves the stored music and text/graphics data from the disk. The player then processes the music (including performing the voice substitution) for playback through an audio system, and generates a video image of the text and/or graphics associated with the song for display on one or several video monitors for viewing by the singer and the audience during the Karaoke performance.

One aspect of conventional Karaoke setups that is not entirely satisfactory is that a Karaoke singer does not know how she looks in the eyes of the audience. Many Karaoke singers enjoy showing off not only their skills in singing but also their abilities to move with the music. Existing Karaoke systems, however, do not allow a Karaoke singer to see herself during her performance. They also do not allow the audience to view the words and watch the singer at the same time.

### SUMMARY OF THE INVENTION

In view of the foregoing, the present invention provides a way to generate a new form of video image for display during a Karaoke performance that allows a singer and her audience to see both the video image of the singer and the text/graphics associated with the song being played on the same video display. The image of the singer is taken with a video camera or the like. The image of text and/or graphics (collectively referred to as “indicia”) associated with the song is extracted from a Karaoke data storage medium, such as a CD+G disk. The indicia image is then downscaled and moved to a first display area, such as the lower portion of the screen. The downscaled and relocated indicia image is then composited with the image of the singer to form an output video image for display on a video monitor. The downscaling and relocation of the indicia associated with the song allows the image of the Karaoke singer to appear on the video monitor in a substantially non-obscured manner. The scaling factor and the position of the scaled indicia may be adjusted to allow optimal visibility of the performer's image. The circuitry for generating the composite video image containing the singer's image and the downscaled and relocated indicia may be implemented in a stand-alone device receiving the indicia image from a Karaoke media player, or as a part of a Karaoke media player.

Additional features and advantages of the invention will be made apparent from the following detailed description of illustrative embodiments, which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram showing a Karaoke system of an embodiment of the invention that displays a composite video image containing the image of a singer and downscaled text of a song being played back;

FIG. 2 is a schematic diagram of an embodiment of a device for generating a composite video image for Karaoke applications in accordance with the invention;

FIG. 3 is a schematic diagram showing an electronic circuit in the device of FIG. 2 for generating composite video images for Karaoke applications;

FIG. 4 is a schematic diagram showing the screen display format of a CD+G video image;

FIG. 5 is a schematic diagram showing a vertical downscaling of a character image area;

FIG. 6 is a table for translating input image cell lines to output image cell lines for relocation of a downscaled image;

FIG. 7 is a schematic diagram showing a CD+G player of an embodiment of the invention that has a subcode pre-processor for performing image downscaling and relocation;

FIG. 8 is a schematic diagram showing components of the subcode pre-processor of FIG. 7;

FIG. 9 is a block diagram showing data flows in the CD+G player of FIG. 7; and

FIG. 10 is a schematic diagram showing a composite video image containing an image of a Karaoke singer and a downscaled text/graphics image with words surrounded by a background.

### DETAILED DESCRIPTION OF THE INVENTION

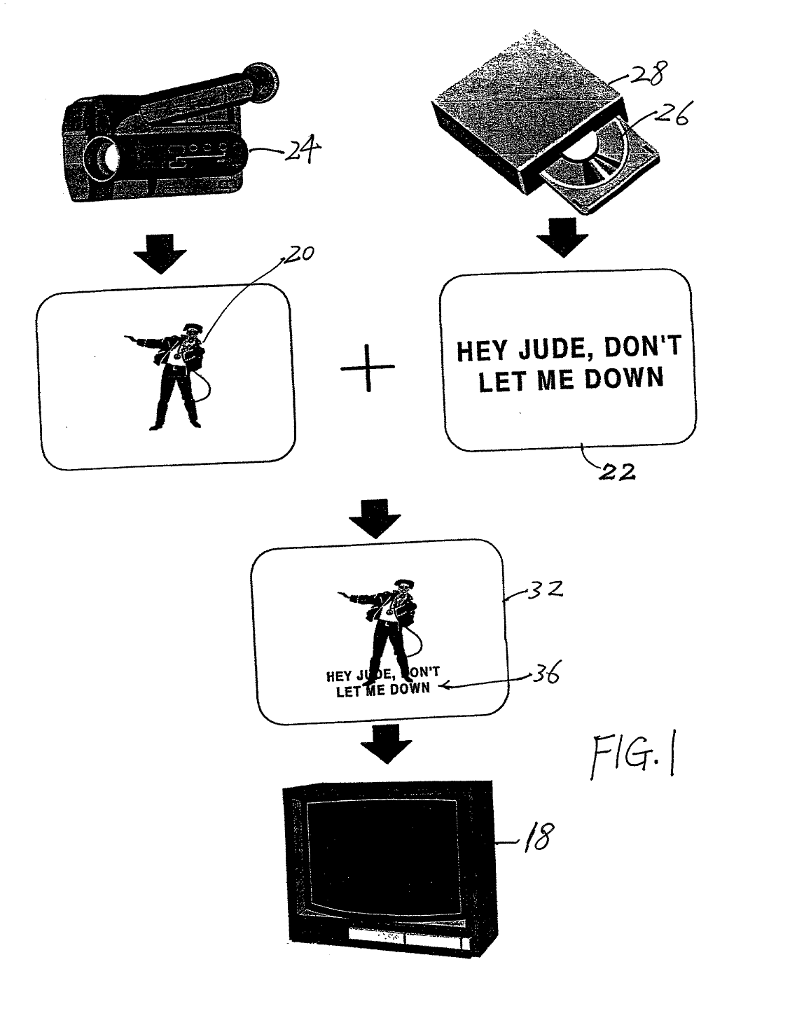

Turning now to the drawings and referring to FIG. 1, the present invention is directed to a Karaoke system that enables a Karaoke singer and the audience to see, on the same video display 18, the image 20 of the singer and the image 22 of the text/graphics (collectively referred to as “indicia”) associated with the song being performed. In the embodiment shown in FIG. 1, the image of the Karaoke singer is captured with a video camera 24. The Karaoke data are stored on a storage medium, such as an optical disk 26, and in a suitable format such as the CD+G format. The CD+G disk 26 is read by a CD+G player 28, which retrieves the audio data as well as text and graphics associated with a song being played back. The text typically contains, but is not limited to, the words of the song being played back. In conventional Karaoke systems, video images of the text/graphics of the song are displayed directly on a video monitor for viewing by the singer and/or the audience. There is no provision in a conventional Karaoke system to allow the singer to view her performance in real time in a mostly non-obscured manner.

In contrast, in accordance with the invention, both the singer's image and the text/graphics of the song are displayed simultaneously on a video display with the image of the text/graphics downscaled and moved to a location that does not obscure significantly the singer's image. Specifically, the video image of the text/graphics is first downscaled and relocated, and then composited with the image of the singer, which may also be downscaled before the compositing if desired. By way of example, in the composite image 32 of FIG. 1, the downscaled image 36 of the text is placed in the lower portion of the composite video image 32, while the image of the Karaoke singer is placed in an upper portion of the video image.

In the composite image 32 shown in FIG. 1, the image of the singer is displayed full scale, and the downscaled text/graphics image is overlaid onto the singer's image in an area that does not significantly obscure the singer's image. In an alternative embodiment, the singer's image may also be downscaled, and the area for the singer's image and the area for the downscaled text/graphics are selected such that they do not overlap to ensure that the singer's image is not obscured by the text, and vice versa. Moreover, the downscaling factor and the location of the scaled indicia may be adjusted to allow optimal viewing of the singer's image and the text/graphics. For instance, instead of the upper-lower arrangement shown in FIG. 1, the singer's image and the text may be positioned in a side-by-side manner or in a picture-in-picture format. Furthermore, in the case of overlaying the text/graphics on the singer's image, the original background (typically of a single color such as blue) of the text/graphics image may be removed so as not to block the singer's image. For example, the composite output video image 32 shown in FIG. 1 shows the effect of the background removal. The background removal operation will be described in greater detail below. Alternatively, the background of the downscaled text/graphics image may be retained in the output video image. An example of such a composite output video image 102 is shown in FIG. 10. Retaining the background 104 in the downscaled text/graphics image 106 ensures the legibility of the words. It will be appreciated that there are many different ways to put the downscaled and repositioned text/graphics image on the same video screen with the singer's image, and such variations do not deviate from the scope and spirit of the invention. Also, it will be appreciated that the compositing is not limited to only two images, and two or more external video images may be combined with the downscaled and repositioned text/graphics image to form the output video image.

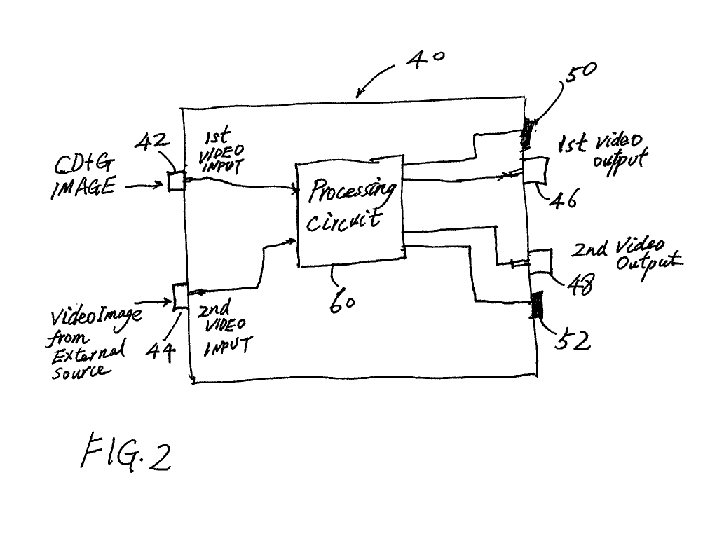

In one embodiment, the indicia downscaling and image compositing are implemented in a stand-alone device 40 (i.e., a device separate from the CD+G player 28 or the like that provides the image of the text/graphics). In a particular implementation as shown in FIG. 2, the device 40 has first and second video inputs 42 and 44. The first video input 42 is for connection to a CD+G player for receiving the video image signals for the indicia associated with a song. The second video input 44 is connected to another video source, which in the context of Karaoke singing may be a video camera for capturing the image of a Karaoke singer as illustrated in FIG. 1. The data entering through the first and second inputs 42 and 44 may be of one of several commonly used formats, such as NTSC, PAL, or SECAM.

The device 40 further includes two video outputs 46 and 48 and two selection buttons 50 and 52 for selecting the type of video image provided at each output. The selection button 50 is for toggling the first video output 48 between the CD+G image received from the player and the composite image of the CD+G indicia image and the video data received by the second input 44. The second selection button 52 toggles the second video output 48 between the video image from the video camera, the indicia image from the CD+G player, and a composite image formed from the two.

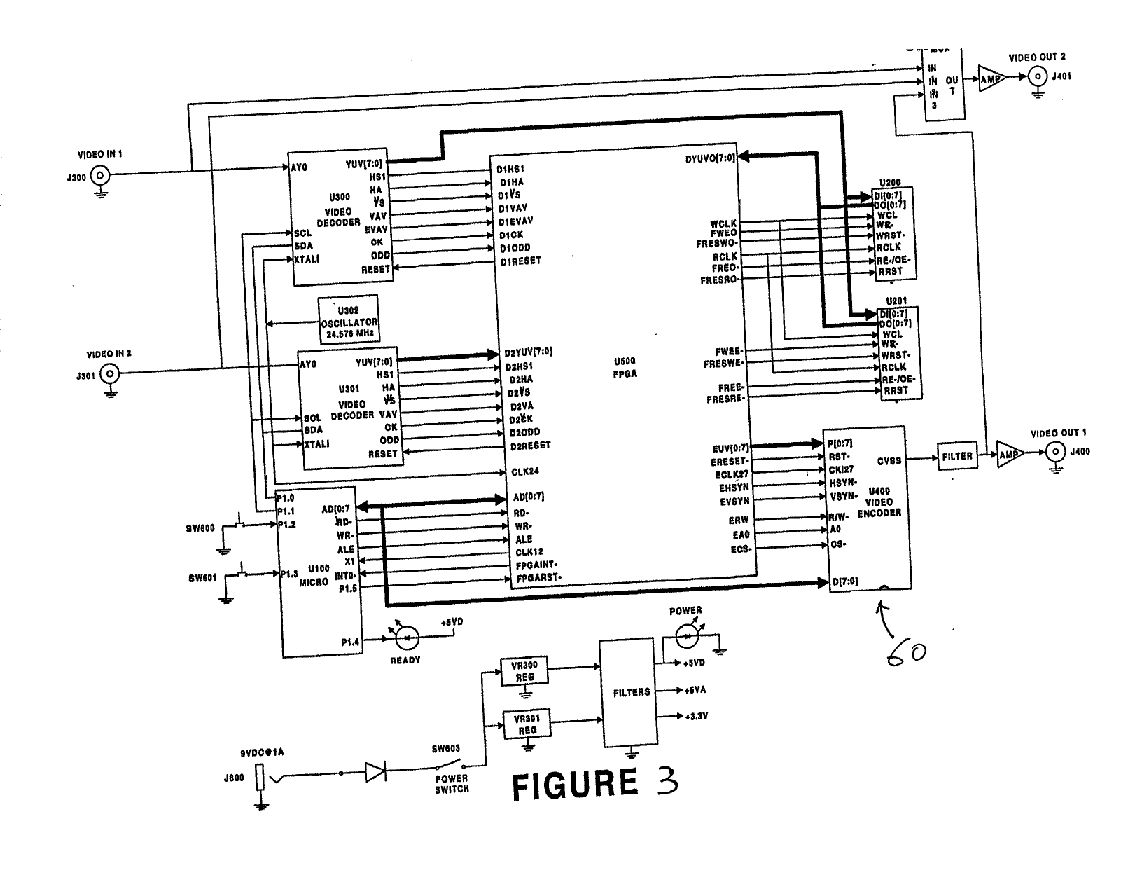

Turning now to FIG. 3, the processing circuit 60 of the device 40 is controlled by a microcontroller (or microprocessor) U100. The video decoder U300 receives the input video image of the text/graphics for a song from the CD+G player 28 or another type of Karaoke data source, and converts the received data into a digital CCIR 656 8-bit format. The video decoder U301, on the other hand, receives the input video data from an external video source such as the video camera 28. Preferably each of the video decoders U300 and U301 is capable of detecting the input format automatically. The microcontroller uses this information to adjust registers in the video decoders and the video encoder U400 for proper operation.

The decoder U300 also downscales the input video data to a software-programmable fraction of the input video. In many Karaoke applications, only a simple vertical downscaling of the text/graphics is required. Such downscaling can be performed by the decoder by selectively discarding video lines. Alternatively, the downscaling of the text/graphics may be performed in both the vertical and horizontal directions, as illustrated in the exemplary video image 32 of FIG. 1. In the embodiment of FIG. 3, the decoder U300 is also capable of performing horizontal downscaling and can be instructed to do so by the microcontroller.

To perform the downscaling, The CCIR 656 data are sent to field memory U200 (odd field) and field memory U201 (even field). The field memories provide a buffer that allows the video data through the first video input (CD+G image) and video data through the second video input (camera image), which are completely asynchronous with respect to each other, to be synchronized for compositing.

To synchronize the data from the two video inputs, the input pointer of the field memories U200 and U201 is reset to address 0 by the vertical sync from the video decoder U300. This vertical sync is derived from the CD+G image input to the first video input. This resetting of the pointer places the beginning of each CD+G image's field data (odd or even) at address 0 of the field memories. Thereafter, input data from the first video input are put in field memories U200 and U201 in CCIR 656 format, using timing derived from the CD+G image received by the first video input 42. The video decoder U300 downscales the input data by selectively dropping lines and pixels, thereby decreasing the amount of data input to the field memories and shrinking the image vertically and horizontally. The CCIR format contains no synchronization information. In this embodiment, data is stored into the field memories at a clock rate of 27 MHz.

The output pointer of field memories U200 and U201 is reset to address 0 by vertical sync from the video decoder U301. This vertical sync is derived from the camera image input into the second video input 44. Data are output from the field memories using timing derived from the camera image into the second video input. The same timing is also used to control the CCIR 656 data input into a video encoder U400. Since the input pointer is at address 0 during vertical sync of the CD+G image and the output pointer is at address 0 during the vertical sync of the camera image, the output data from the field memories (scaled CD+G image) is synchronized with the camera image.

Once the scaled CD+G image and the camera image are synchronized as described above, the indicia (i.e., text and/or graphics) from the CD+G image is extracted. To accomplish this, the scaled CD+G data from the field memories U300 and U301 are sent to the field-programmable gate array (FPGA) U500. The FPGA, under the control of the microcontroller U100, samples the CCIR 656 data from the CD+G image to determine the Y, U, and V components of the scaled CD+G image's background. The FPGA can be directed to sample any line and pixel of either field in the image. When the data has been captured by the FPGA, the microcontroller is interrupted. Multiple samples from the edges of the scaled CD+G image are gathered and averaged. Various algorithms can be implemented by the microcontroller to determine the validity of the background data. Samples are taken periodically since the background color may change from time to time. The resultant Y, U, and V data from the sampling algorithm are used by the microcontroller U100 to determine a valid range of values for Y, U, and V. These ranges are loaded into respective high-value and low-value registers in the FPGA for Y, U, and V. These ranges of values from the registers are continuously compared to the CCIR 656 data from the scaled CD+G image. The results of the comparison determine when the background is present on the CD+G image. Since the microcontroller U100 is continuously sampling the background, no user intervention is required when the background Y, U, and V changes.

When the background is present, the CCIR 656 data input to the video encoder U400 is from the camera image. Conversely, the CCIR 656 data from the CD+G image is input to the video encoder U400 when the background is not present. This multiplexing function is implemented in the FPGA. The timing is such that the alignment of the data input to the encoder is synchronized with the background comparison so that a minimal amount of background pixels appear in the encoder's video output.

In addition to downscaling, the CD+G indicia image is also repositioned to a pre-selected area. In one embodiment, the new location for the scaled image is the lower portion of the composite video image. This is accomplished by delaying the output from the field memories for a fixed number of horizontal lines after vertical sync. During this delay, the multiplexer for the encoder CCIR 656 data is forced to send only data from the camera image to the encoder.

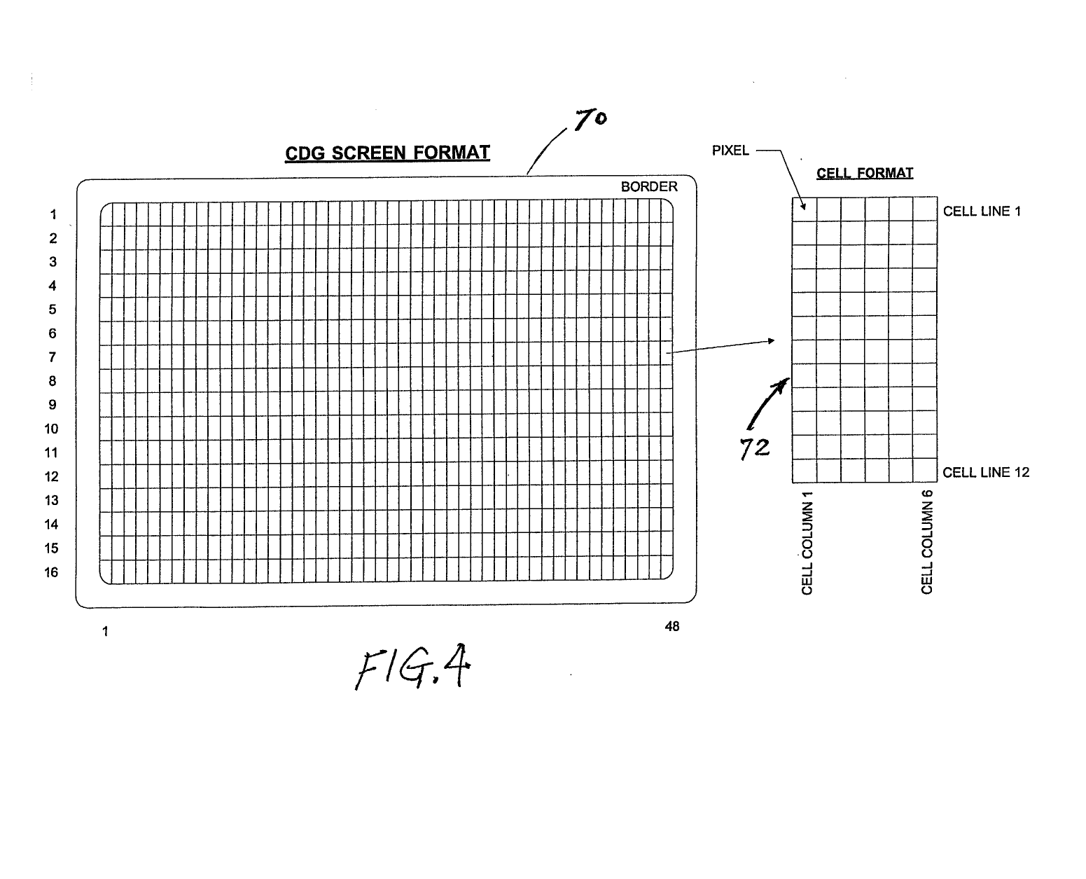

Turning now to FIG. 4, the CD+G display image 70 from the CD+G player is divided into cells, and there are 16 rows and 48 columns of cells on a video screen. Each cell 72 is 6 dots (pixels) wide by 12 dots high. The microcontroller U100 instructs the video decoder U300 to downscale the cell contents vertically by selectively dropping lines and horizontally by interpolating and dropping pixels. After downscaling, the cells are relocated to the lower portion of the display image.

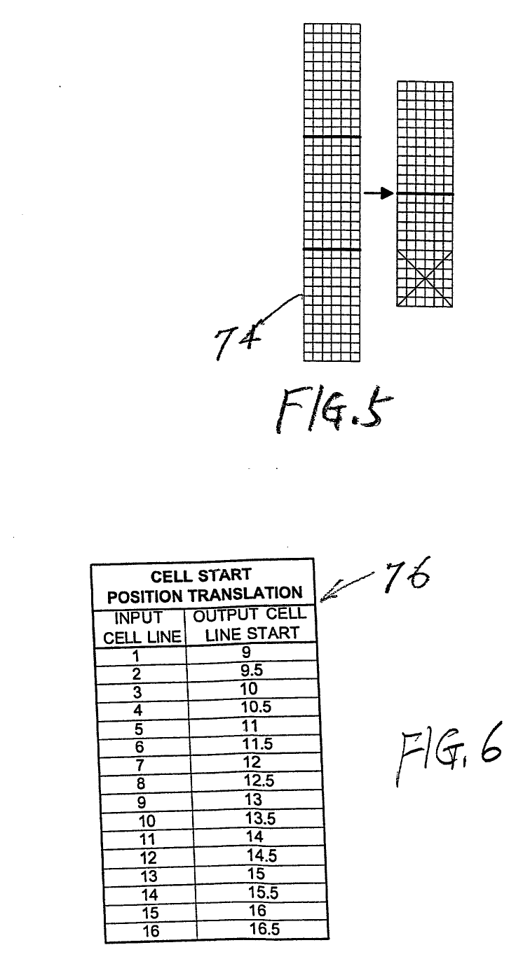

By way of example, FIG. 5 shows how a 3-cell high character area 74 is converted to a height of 1.5 cells by a simple vertical downscaling operation that drops even lines to achieve a vertical scaling factor of 50%. The vertically downscaled cell can then be repositioned to the lower half of the screen. FIG. 6 shows, as an example, a position translation table that provides the input cell start lines and the corresponding output image cell start lines.

In an alternative embodiment of the invention, the scaling and compositing functions are implemented as part of a CD+G player instead of in a stand-alone device as in the embodiment of FIG. 2. This embodiment takes advantage of some current CD+G decoder chips, such as Yamaha YVZ155 and Sanyo LC7872, that are capable (with the addition of external components) of performing a video overlay of an external video source. Such video overlay function is sometimes referred to as the “superimpose” function. Unfortunately, in most cases the CD+G text image covers most of the screen and tends to obscure the video from the external source. For this reason, manufacturers of CD+G players no longer add the external circuitry required to implement the superimpose function. The present embodiment utilizes the superimpose function of the decoder chips to perform video image compositing after the CD+G text/graphics image is downscaled and moved to a portion of the video image that is less likely to obscure the image from the external source, such as a video camera for capturing the images of a Karaoke singer. By using the built-in superimpose function of a CD+G decoder chip, the cost of implementing the circuitry for generating the composite video images in accordance with the invention is significantly reduced.

Specifically, the CD+G disk contains a low speed stream that contains the text/graphics information to be displayed on a video monitor. In conventional CD+G players, this data stream is sent to a CD+G decoder chip, such as the Yamaha YVZ155 or the Sanyo LC7872 chip, via a synchronous serial interface. This interface is commonly called the “subcode interface.” The subcode interface controls the contents of the cells of the CD+G display image.

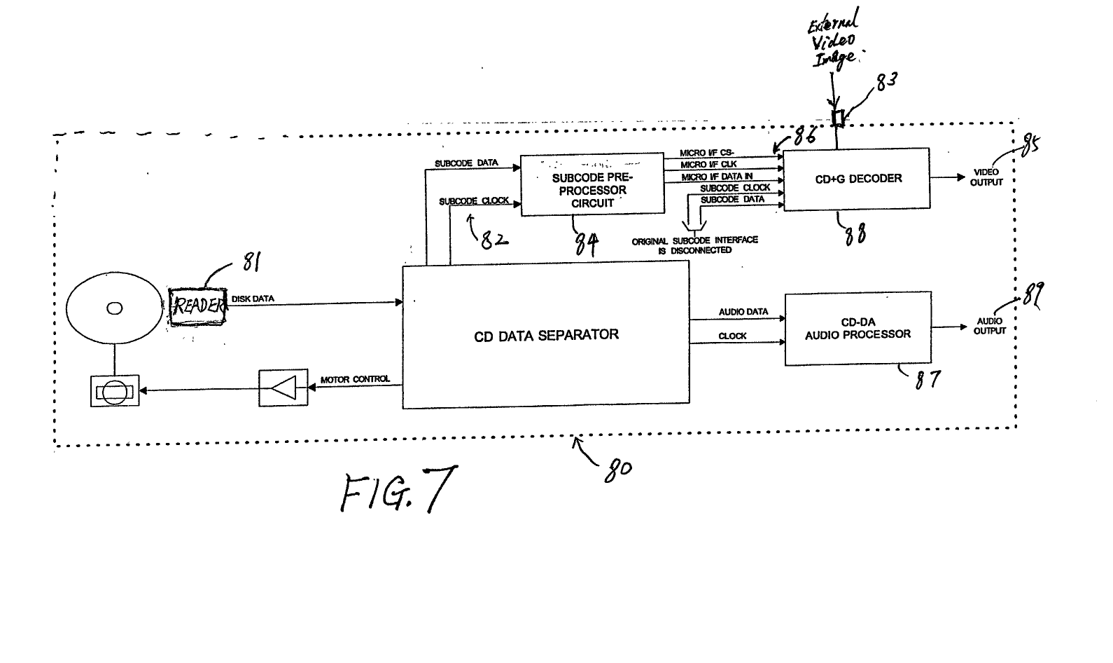

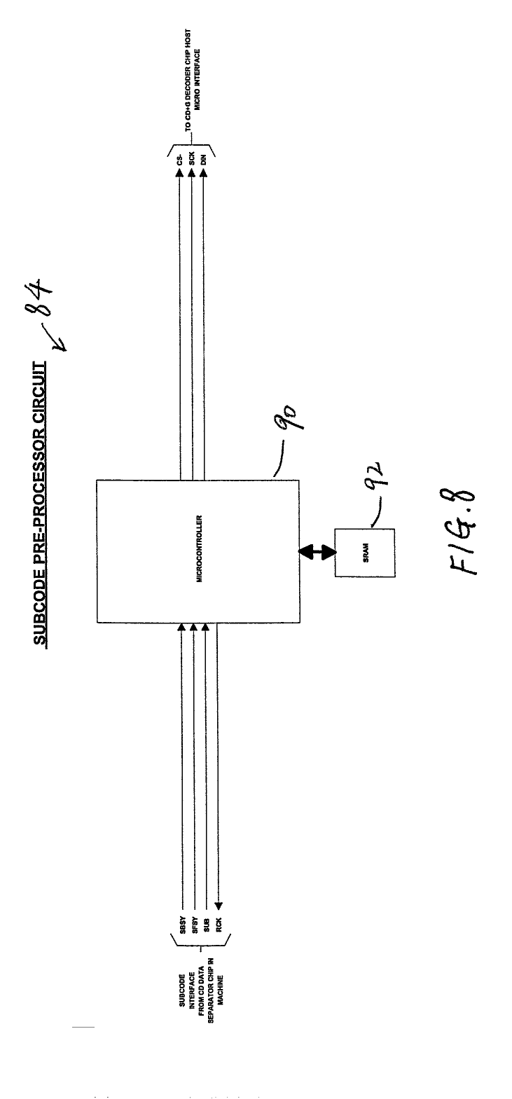

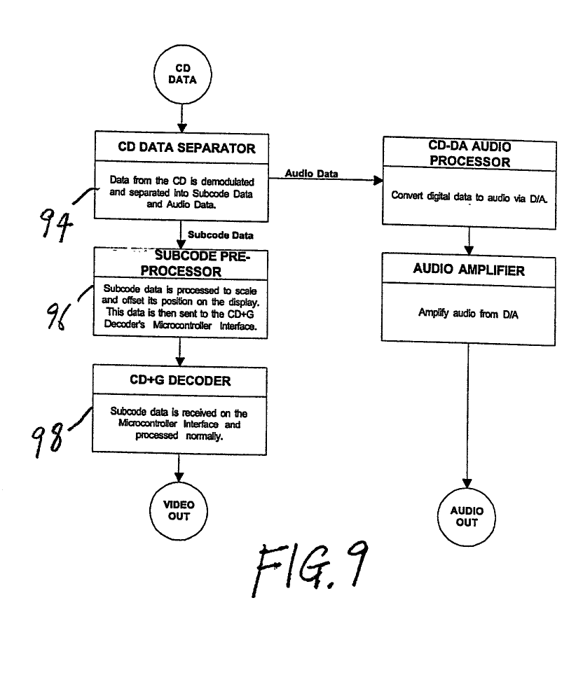

Referring to FIG. 7, a CD+G player 80 according to the embodiment has a reader 81 for reading data from a CD+G disk. The player 80 further includes an external video input 83 for receiving an external video image, which may be, for example, the video image of a Karaoke singer captured by a video camera. The data retrieved from the disk include both the audio data and data representing text/graphics images associated with a song being played back. The audio data are processed by an audio processor 87, and the output audio signal from the audio processor is sent to an audio output 89 for play back by an external audio system. The subcode data stream 82 containing the indicia (i.e., text and/or graphics) data is intercepted by a subcode pre-processor 84, which is inserted into the subcode data stream before the CD+G decoder 88. The subcode pre-processor 84 modifies the data by scaling and relocating the image, and sends the modified data to the microprocessor interface 86 of the CD+G decoder 88. The subcode interface of the CD+G decoder is left disconnected. The microprocessor interface of the CD+G decoder 88 is used because it is faster than the subcode interface and allows access to the internal register of the CD+G decoder. Using the faster microprocessor interface of the CD+G decoder maintains the original subcode data throughput to the CD+G decoder while allowing additional time for the microcontroller to implement the scaling algorithm.

As shown in FIG. 8, the subcode pre-processor 84 contains a high-speed microcontroller 90 with external high speed random-access memory (RAM) 92. The microcontroller 90 is programmed to scale the CD+G text/graphics and move it to a lower portion of the screen or any area that is less likely to obscure the video image from the external source.

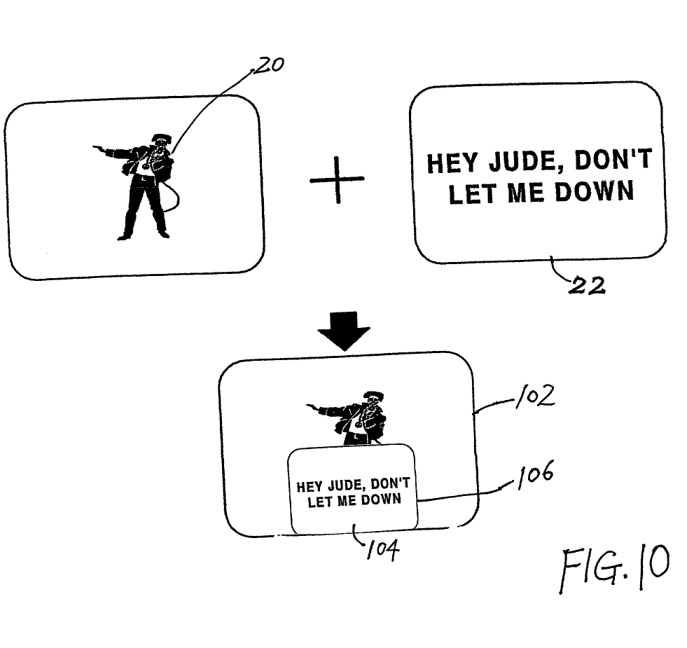

The data flow in the modified CD+G player 80 of FIG. 7 is illustrated in FIG. 9. As shown in FIG. 9, data read from a Karaoke compact disk (CD) is demodulated and separated into subcode data and audio data (step 94). The subcode data are processed by the subcode pre processor to scale the indicia and offset its position on the video display (step 96). The processed data are then sent to the CD+G decoder's microprocessor interface. The CD+G decoder then processes the modified subcode data received through the microprocessor interface (step 98). This processing includes superimposing the modified indicia image with the video image received from an external video source, such as a video camera used to capture images of a Karaoke singer.

The microcontroller 90 of the subcode pre-processor 84 performs the scaling and repositioning of the indicia image in the subcode data in substantially the same way as that described above in connection with the first embodiment. The extraction of the CD+G indicia from the background color for compositing is also similar to that of the first embodiment. Specifically, to extract the CD+G indicia from the background, the microcontroller 90 obtains the background color information by intercepting the subcode data stream and examining the data fields that define the background. The microcontroller 90 continuously monitors this background color information on the subcode interface and writes it to the specific registers in the CD+G decoder, thus providing the CD+G decoder chip 88 with the background color information. The registers define reference values inside the CD+G decoder chip 88 to be used to differentiate the background color from all other colors it outputs to display. Externally, a signal from the CD+G decoder is activated when the background color is detected. This signal is then used to switch between the video output of the CD+G decoder and that of the external video signal source.

As described above, an especially advantageous application of the circuitry for generating the composite video image, either implemented in a stand-alone device or as part of a CD+G player or the like, is to display the image of a Karaoke singer together with the words of a song being performed. It will be appreciated, however, that the use of the circuitry is not limited to only that application. Rather, video images other than images of a Karaoke singer from the same or other types of external video sources may be composited with scaled and relocated text/graphics from a Karaoke medium. For instance, the external video images may be pre-recorded images, images of the audience, advertisement video clips, etc.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

What is claimed is:

1. A Karaoke system comprising:
a video image capturing device for capturing a video image of a Karaoke performer;
a Karaoke medium player for retrieving audio signals and an indicia image of a song from a Karaoke medium;
means for downscaling and repositioning the indicia image;
means for compositing the downscaled and repositioned indicia image with the image of the Karaoke performer to provide an output video image;
a video monitor for displaying the composite output video image.

2. A Karaoke system as in claim 1, wherein the indicia image contains words for the song.

3. A Karaoke system as in claim 1, wherein the means for compositing overlays the downscaled and repositioned indicia image on the image of the Karaoke performer.

4. A Karaoke system as in claim 1, wherein the means for compositing removes a background of the downscaled and repositioned indicia image before overlaying the downscaled and repositioned indicia image on the image of the Karaoke performer.

5. A Karaoke system as in claim 1, wherein the means for downscaling and the means for compositing are implemented in a stand-alone device separate from the Karaoke medium player.

6. A Karaoke system as in claim 1, wherein the means for downscaling and means for compositing are implemented as components of the Karaoke medium player.

7. A Karaoke system as in claim 6, wherein the Karaoke medium player is a compact-disk-plus-graphics (CD+G) player.

8. A Karaoke system as in claim 1, wherein the means for downscaling vertically downscales the indicia image by selectively dropping lines of the indicia image.

9. A Karaoke video image processing device comprising:
a first video input for receiving from a Karaoke medium player an indicia image associated with a song being played back;
a second video input for receiving a second video image from a second external video source;
an electronic circuit to downscale and reposition the indicia image and to composite the downscaled and repositioned indicia image with the second video image to form an output video image;
a video output for outputting the output video image for display.

10. A Karaoke video image processing device as in claim 9, wherein the electronic circuit overlays the downscaled and repositioned indicia image on the second video image to form the output video image.

11. A Karaoke video image processing device as in claim 10, wherein the electronic circuit removes a background of the downscaled and repositioned indicia image before overlaying the downscaled and repositioned indicia image on the second video image.

12. A Karaoke medium player comprising:
a reader for retrieving data from a Karaoke medium, the data comprising audio data and an indicia image;
an external video input for receiving an external video image;
a video processing circuit for downscaling and repositioning the indicia image and combining the downscaled and repositioned indicia image with the external video image to from an output video image;
a video output for outputting the output video image;
an audio processor for processing the audio data to provide an output audio signal; and
an audio output for outputting the output audio signal.

13. A Karaoke medium player as in claim 12, wherein the video processing circuit removes a background of the downscaled and repositioned indicia image before compositing the downscaled and repositioned indicia image with the external video image.

14. A Karaoke medium player as in claim 12, wherein the Karaoke medium is a compact-disk-plus-graphics (CD+G) disk.

15. A Karaoke medium player as in claim 14, wherein the video processing circuit includes a CD+G decoder for compositing the downsized and repositioned indicia image with the external video image.

16. A Karaoke medium player as in claim 12, wherein the video processing circuit includes a subcode processor for receiving a stream of subcode data retrieved from the Karaoke medium representing the indicia image and modifying the subcode data to effect the downscaling and repositioning.

17. A Karaoke medium player as in claim 16, wherein the Karaoke medium is a compact-disk-plus-graphics (CD+G) disk and the video processing circuit further includes a CD+G decoder, and wherein the subcode processor sends the modified subcode data to a microprocessor interface of the CD+G decoder.

18. A method of generating video images for Karaoke applications, comprising the steps of:
capturing a video image of a Karaoke performer;
retrieving audio data and an indicia image associated with a song being performed by the Karaoke performer;
downscaling and repositioning the indicia image;
compositing the downscaled and repositioned indicia image with the image of the Karaoke performer to form an output video image; and
displaying the output video image on a video monitor.

19. A method as in claim 18, wherein the step of compositing includes removing a background of the downscaled and repositioned indicia image.

20. A method as in claim 18, wherein the step of downscaling reduces a vertical height of the indicia image by line dropping.
